(19) United States
(12) Patent Application Publication
(10) Pub. No.: US 2017/0147134 A1
(43) Pub. Date: May 25, 2017

(54) METHOD AND APPARATUS FOR CONTROLLING TOUCH-SCREEN SENSITIVITY

(71) Applicant: Xiaomi Inc., Beijing (CN)

(72) Inventors: Zhongsheng JIANG, Beijing (CN); Kun YANG, Beijing (CN); Dan LIU, Beijing (CN)

(73) Assignee: Xiaomi Inc.

(21) Appl. No.: 15/407,453

(22) Filed: Jan. 17, 2017

Related U.S. Application Data
(63) Continuation of application No. PCT/CN2016/100863, filed on Sep. 29, 2016.

(30) Foreign Application Priority Data
Nov. 25, 2015 (CN) 201510834182.7

(51) Int. Cl. G06F 3/041; G06F 1/32

(52) U.S. Cl. CPC G06F 3/0416; G06F 1/3262

(57) ABSTRACT

The present disclosure relates to a method and apparatus for controlling touch-screen sensitivity. The method includes: receiving a first status signal sent by a power management device of a terminal when the power management device detects a charging port of the terminal is in a connected state, the first status signal indicating the charging port is in the connected state; setting a first sensitivity threshold corresponding to the first status signal; processing touch events sensed by a touch screen of the terminal to generate touch-point information according to the first sensitivity threshold; and sending the touch-point information generated according to the first sensitivity threshold to a computing device of the terminal.

### CROSS-REFERENCE TO RELATED APPLICATIONS

This application is a continuation of International Application No. PCT/CN2016/100863, filed Sep. 29, 2016, which is based upon and claims priority to Chinese Patent Application No. 201510834182.7, filed Nov. 25, 2015, the entire contents of all of which are incorporated herein by reference.

### TECHNICAL FIELD

The present disclosure generally relates to the field of terminal technology and, more particularly, to a method and apparatus for controlling touch-screen sensitivity.

### BACKGROUND

With constant development of the terminal technology, smart phones provide many new features that greatly improve user experience of the phones. Currently, more and more smart phones are equipped with touch screens. However, when a smart phone is connected to a charger or other terminals, the smart phone's touch screen often has increased sensitivity and thus may be prone to reporting erroneous touch events. This issue causes trouble and inconvenience to the smart-phone users.

### SUMMARY

According to a first aspect of the present disclosure, there is provided a method for use in a touch screen of a terminal, the method comprising: receiving a first status signal sent by a power management device of the terminal when the power management device detects a charging port of the terminal is in a connected state, the first status signal indicating the charging port is in the connected state; setting a first sensitivity threshold corresponding to the first status signal; processing touch events sensed by the touch screen to generate touch-point information according to the first sensitivity threshold; and sending the touch-point information generated according to the first sensitivity threshold to a computing device of the terminal.

According to a second aspect of the present disclosure, there is provided an apparatus for controlling sensitivity of a touch screen of a terminal, the apparatus comprising: a processor, and a memory configured to store instructions executable by the processor; wherein the processor is configured to: receive a first status signal sent by a power management device of the terminal when the power management device detects a charging port of the terminal is in a connected state, the first status signal indicating the charging port is in the connected state; set for the touch screen a first sensitivity threshold corresponding to the first status signal; process touch events sensed by the touch screen to generate touch-point information according to the first sensitivity threshold; and send the touch-point information generated according to the first sensitivity threshold to a computing device of the terminal.

According to a third aspect of the present disclosure, there is provided a non-transitory computer-readable storage medium comprising instructions that, when executed by a processor of a terminal, causes the terminal to perform a method for controlling sensitivity of a touch screen of the terminal, the method comprising: receiving a first status signal sent by a power management device of the terminal when the power management device detects a charging port of the terminal is in a connected state, the first status signal indicating the charging port is in the connected state; setting for the touch screen a first sensitivity threshold corresponding to the first status signal; processing touch events sensed by the touch screen to generate touch-point information according to the first sensitivity threshold; and sending the touch-point information generated according to the first sensitivity threshold to a computing device of the terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for controlling touch-screen sensitivity, according to an exemplary embodiment.

FIG. 2 is a flowchart of a method for controlling touch-screen sensitivity, according to an exemplary embodiment.

FIG. 3 is a schematic diagram illustrating an implementation of a method for controlling touch-screen sensitivity, according to an exemplary embodiment.

FIG. 4 is a block diagram of an apparatus for controlling touch-screen sensitivity, according to an exemplary embodiment.

FIG. 5 is a block diagram of a first receiving module in the apparatus shown in FIG. 4, according to an exemplary embodiment.

FIG. 6 is a block diagram of a first setting module in the apparatus shown in FIG. 4, according to an exemplary embodiment.

FIG. 7 is a block diagram of a first processing module in the apparatus shown in FIG. 4, according to an exemplary embodiment.

FIG. 8 is a block diagram of an apparatus for controlling touch-screen sensitivity, according to an exemplary embodiment.

FIG. 9 is a block diagram of a second receiving module in the apparatus shown in FIG. 8, according to another exemplary embodiment.

FIG. 10 is a block diagram of a second setting module in the apparatus shown in FIG. 8, according to an exemplary embodiment.

FIG. 11 is a block diagram of a second processing module in the apparatus shown in FIG. 8, according to an exemplary embodiment.

FIG. 12 is a block diagram of an apparatus for controlling touch-screen sensitivity, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the invention as recited in the appended claims.

Terms used in the present disclosure are only for the purpose of describing specific embodiments, and are not intended to limit the present disclosure. As used in the present disclosure and appended claims, the singular forms of “a/an”, “said,” and “the” intend to also include the plural forms, unless the context clearly dictates otherwise. It should also be understood that the term “and/or” used herein is intended to include arbitrary and all possible combinations of one or more items listed in association.

It should be understood that terms such as “first,” “second,” “third,” and the like are used herein for describing various information. However, the described information shall not be restricted to these terms. These terms are only intended to distinguish among information of the same type. For example, without departing from the scope of the present disclosure, first information can be referred to as second information. Similarly, second information can also be referred to as first information. Moreover, depending on the context, the term “if” used herein can be interpreted as “when,” “while,” or “in response to determining.”

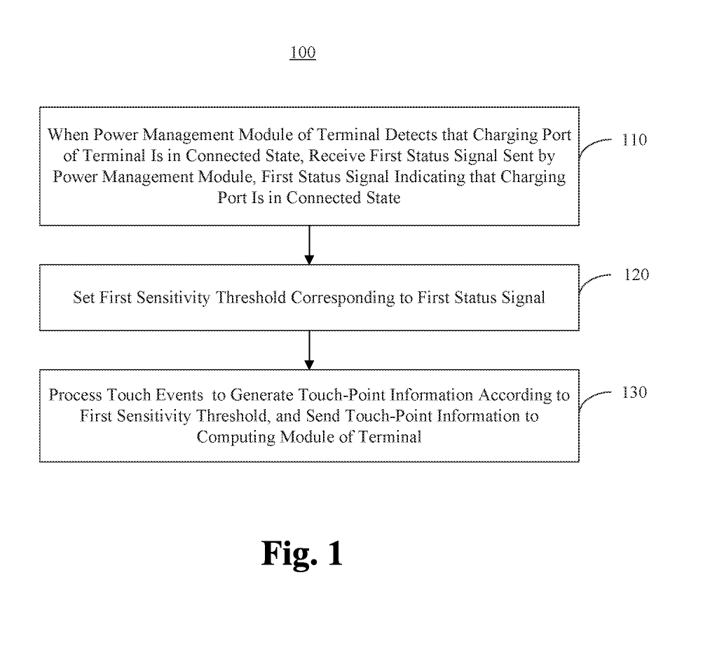

FIG. 1 is a flowchart of a method 100 for controlling touch-screen sensitivity, according to an exemplary embodiment. For example, the method 100 may be applied to a touch screen of a terminal.

The terminal can be any device having a touch screen. For example, the terminal may be a mobile phone, a tablet computer, a personal digital assistant (PDA), a personal computer, and so on. In some embodiments, the terminal is connected to a router by means of wireless local area network (WLAN) and accesses a server in a public network through the router.

Consistent with the disclosed embodiments, the terminal includes a power management module (i.e., a power processing module), a touch screen, and a computing module. The computing module further includes a central processing unit (CPU), a memory, etc.

Referring to FIG. 1, the method 100 includes the following steps 110-130. In step 110, when the power management module of the terminal detects that a charging port of the terminal is in a connected state, the touch screen receives a first status signal sent by the power management module. The first status signal indicates that the charging port is in the connected state.

In the present disclosure, the “connected state” refers to a state in which the terminal is connected to a charger and charged through the charger, or a state in which the terminal is connected to another terminal and exchanges data with the other terminal.

In step 120, the touch screen sets a first sensitivity threshold corresponding to the first status signal.

In the disclosed embodiments, the touch screen resets the sensitivity threshold when the charging port of the terminal is in the connected state. For example, the touch screen may set a higher sensitivity threshold to prevent the touch screen from reporting touch events by error due to noise caused by common-mode interference.

In step 130, the touch screen processes touch events according to the first sensitivity threshold to generate touch-point information, and sends the touch-point information to the computing module of the terminal.

According to the method 100, when it is learned that the charging port is in the connected state, the touch screen automatically sets a corresponding sensitivity threshold. This way, the accuracy rate in processing touch events by the touch screen is improved.

In the disclosed embodiments, the receiving of the first status signal sent by the power management module (step 110) may be implemented in one of the following two reception modes.

In the first reception mode, the touch screen receives the first status signal directly from the power management module. For example, the power management module directly sends the first status information to the touch screen by means of hardware interrupt.

In the second reception mode, the first status signal is first sent by the power management module to the computing module and then forwarded by the computing module to the touch screen. For example, the power management module first sends the first status signal to the computing module in the form of software instructions, and the computing module subsequently forwards the first status signal to the touch screen.

As such, the power management module can send the first status signal to the touch screen by means of hardware interrupt or software instructions. This way, the terminal can be flexibly designed, and the touch screen's efficiency in processing touch events is improved.

In some embodiments, when the first sensitivity threshold is set corresponding to the first status signal (step 120), the touch screen also sets a first scanning frequency corresponding to the first status signal. Accordingly, in step 130, the touch screen can process the touch events according to both the first sensitivity threshold and the first scanning frequency.

As such, after receiving the first status signal, the touch screen sets a first sensitivity threshold and a first scanning frequency, and processes the touch events according to the first sensitivity threshold and the first scanning frequency. This way, the error of the generated touch-point information can be minimized. Therefore, use confusion due to erroneous touch-point reporting can be avoided, and user experience of the terminal is improved.

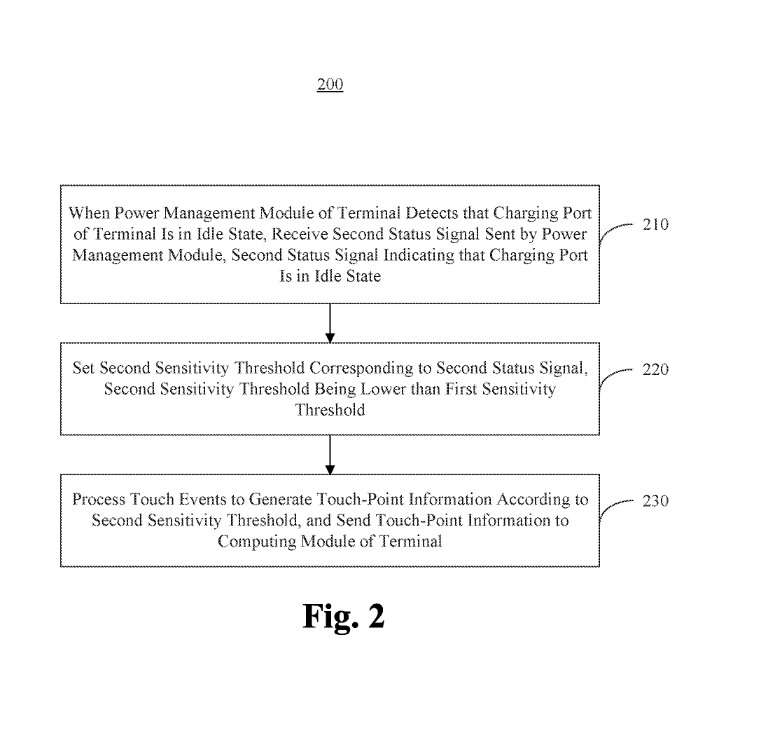

FIG. 2 is a flowchart of a method 200 for controlling touch-screen sensitivity, according to an exemplary embodiment. For example, the method 200 may be performed by the touch screen of the terminal and implemented in conjunction with the method 100. Referring to FIG. 2, the method 200 includes the following steps 210-230.

In step 210, when the power management module detects that the charging port is in an idle state, the touch screen receives a second status signal sent by the power management module. The second status signal indicates that the charging port is in the idle state.

In step 220, the touch screen sets a second sensitivity threshold corresponding to the second status signal. The second sensitivity threshold is lower than the first sensitivity threshold.

In the disclosed embodiments, the touch screen resets the sensitivity threshold when the charging port of the terminal is in the idle state. For example, the touch screen may set a lower sensitivity threshold to process the touch events sensed by the touch screen.

In step 230, the touch screen processes touch events according to the second sensitivity threshold to generate touch-point information, and sends the touch-point information to the computing module.

According to the method 200, the second sensitivity threshold is set to be lower than the first sensitivity threshold. This way, the method 200 not only guarantees the touch events sensed by the touch screen are properly reported, but also saves energy consumption and improves the performance of the terminal.

In the disclosed embodiments, the receiving of the second status signal sent by the power management module (step 210) may be implemented in one of the following two reception modes.

In the first reception mode, the touch screen receives the second status signal directly from the power management module. For example, the power management module directly sends the second status signal to the touch screen by means of hardware interrupt.

In the second reception mode, the second status signal is first sent by the power management module to the computing module and then forwarded by the computing module to the touch screen. For example, the power management module first sends the second status signal to the computing module in the form of software instructions, and the computing module subsequently forwards the second status signal to the touch screen.

As such, the power management module can send the second status signal to the touch screen by means of hardware interrupt or software instructions. This way, the terminal can be flexibly designed, and the touch screen's efficiency in processing the touch events sensed by the touch screen is improved.

In some embodiments, when the second sensitivity threshold is set corresponding to the second status signal (step 220), the touch screen also sets a second scanning frequency corresponding to the second status signal. Accordingly, in step 230, the touch screen can process the touch events according to both the second sensitivity threshold and the second scanning frequency.

As such, after receiving the second status signal, the touch screen sets a second sensitivity threshold and a second scanning frequency, and processes the touch events according to the second sensitivity threshold and second scanning frequency. This way, the error of the generated touch-point information can be minimized Therefore, the user confusion due to erroneous touch-point reporting can be avoided, and the user experience of the terminal is improved.

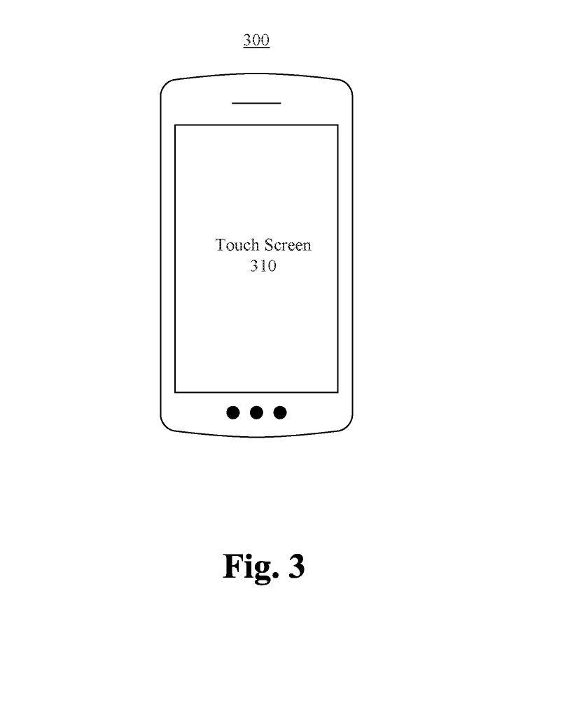

FIG. 3 is a schematic diagram illustrating an implementation of the disclosed methods for controlling touch-screen sensitivity, according to an exemplary embodiment. Referring to FIG. 3, the terminal in the methods 100 and 200 is implemented as a smart phone 300. The smart mobile phone 300 includes a power management module (not shown), a charging port (not shown), a computing module (not shown), and a touch screen 310.

The power management module is configured to detect the connection status of the charging port. When it is detected that the charging port is in a connected state, the power management module sends a first status signal to the touch screen 310 directly or via the computing module. The first status signal indicates that the charging port is in the connected state. Similarly, when it is detected that the charging port is in an idle state, the power management modules sends a second status signal used to the touch screen 310 directly or via the computing device. The second status signal indicates that the charging port is in the idle state.

The touch screen 310 is configured to adjust the manner of processing the touch events sensed by the touch screen 310, according to the received status signals. After the first status signal is received, the touch screen 310 sets a first sensitivity threshold corresponding to the first status signal, and processes the touch events to generate the touch-point information according to the first sensitivity threshold. Similarly, after the second status signal is received, the touch screen 310 sets a second sensitivity threshold corresponding to the second status signal, and processes the touch events to generate the touch-point information according to the second sensitivity threshold. In both cases, the touch screen 310 sends the generated touch-point information to the computing module.

Corresponding to the above-described embodiments of the methods for controlling touch-screen sensitivity, the present disclosure also provides embodiments of apparatuses for controlling touch-screen sensitivity.

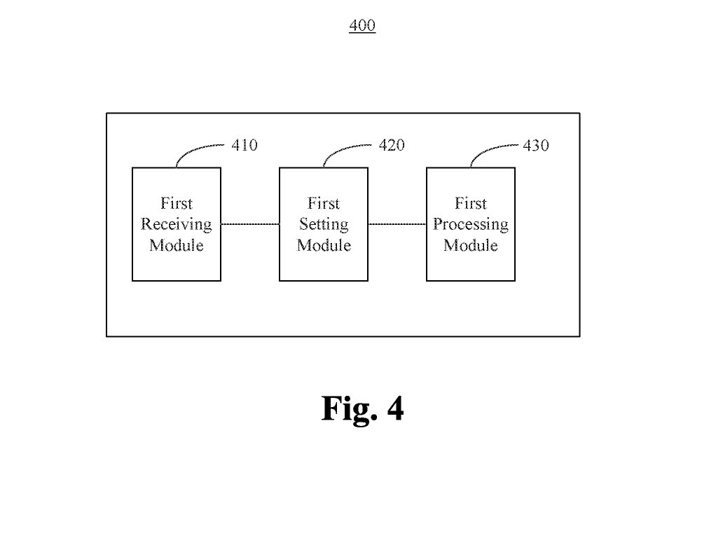

FIG. 4 is a block diagram of an apparatus 400 for controlling touch-screen sensitivity, according to an exemplary embodiment. The apparatus 400 may be implemented as a part or the whole of a touch screen of a terminal and used for executing the method 100 (FIG. 1) and/or method 200 (FIG. 2). Referring to FIG. 4, the apparatus 400 includes a first receiving module 410, a first setting module 420, and a first processing module 430.

The first receiving module 410 is configured to receive a first status signal sent by a power management module of the terminal, when the power management module detects that a charging port of the terminal is in a connected state. The first status signal indicates that the charging port is in the connected state.

The first setting module 420 is configured to set a first sensitivity threshold corresponding to the first status signal.

The first processing module 430 is configured to process touch events sensed by the touch screen according to the first sensitivity threshold to generate touch-point information, and send the touch-point information to a computing module of the terminal.

In the disclosed embodiments, the first status signal received by the first receiving module 410 may be directly transmitted from the power management module to the first receiving module 410 by means of hardware interrupt. Alternatively, the first status signal may be first sent by the power management module to the computing module by means of software instructions, and then forwarded by the computing module to the first receiving module 410.

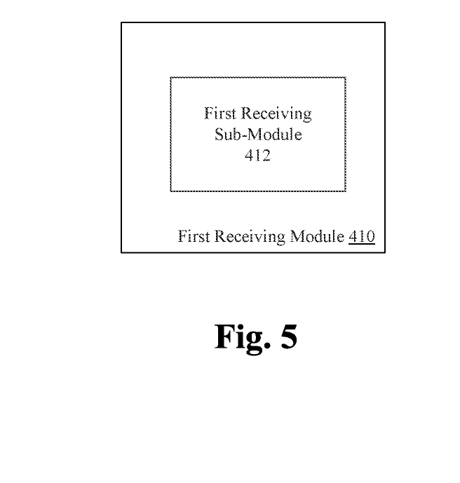

FIG. 5 is a block diagram of the first receiving module 410 shown in FIG. 4, according to another exemplary embodiment. Referring to FIG. 4, the first receiving module 410 further includes a first receiving sub-module 412.

The first receiving sub-module 412 is configured to receive the first status signal from the computing module. That is, the first status signal is first sent by the power management module to the computing module and then forwarded by the computing module to the first receiving sub-module 412. In this embodiment, the first status signal is transmitted between the power management module, the computing module, and the first receiving sub-module 412 by means of software instructions.

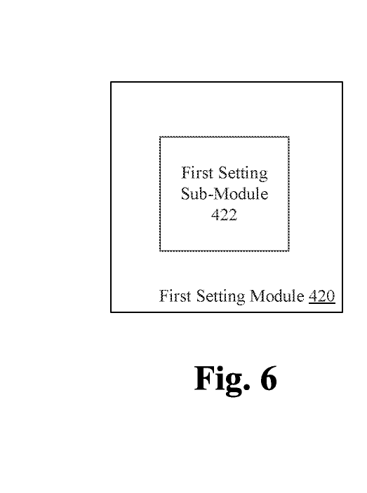

FIG. 6 is a block diagram of the first setting module 420 shown in FIG. 4, according to another exemplary embodiment. Referring to FIG. 6, the first setting module 420 further includes a first setting sub-module 422.

The first setting sub-module 422 is configured to set a first scanning frequency corresponding to the first status signal.

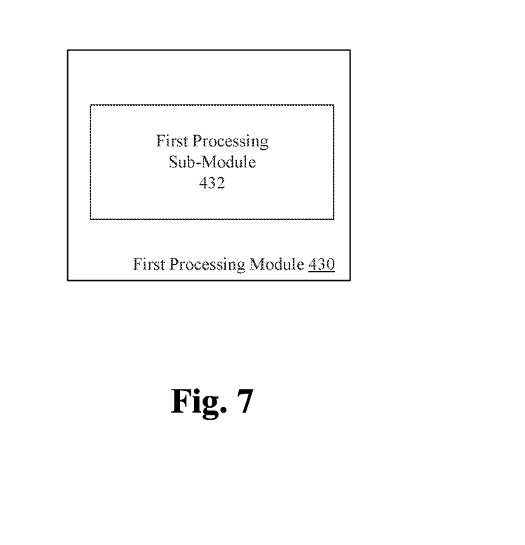

FIG. 7 is a block diagram of the first processing module 430 shown in FIG. 4, according to another exemplary embodiment. Referring to FIG. 7, the first processing module 430 further includes a first processing sub-module 432.

The first processing sub-module 432 works in conjunction with the first setting sub-module 422 (FIG. 6) and is configured to process touch events sensed by the touch screen, according to the first sensitivity threshold and the first scanning frequency.

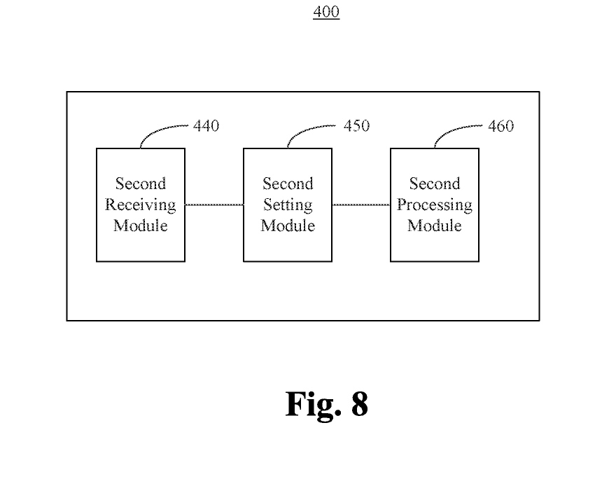

FIG. 8 is a block diagram of the apparatus 400 shown in FIG. 4, according to another exemplary embodiment. Referring to FIG. 8, in addition to the first receiving module 410, the first setting module 420, and the first processing module 430 (not shown in FIG. 8), the apparatus 400 further includes a second receiving module 440, a second setting module 450, and a second processing module 460.

The second receiving module 440 is configured to receive a second status signal sent by the power management module when the power management module detects that the charging port is in an idle state. The second status signal indicates that the charging port is in the idle state.

The second setting module 450 is configured to set a second sensitivity threshold corresponding to the second status signal. The second sensitivity threshold is lower than the first sensitivity threshold.

The second processing module 460 is configured to process the touch events sensed by the touch screen according to the second sensitivity threshold to generate the touch-point information, and send the touch-point information to the computing module.

In the disclosed embodiments, the second status signal received by the second receiving module 440 may be directly transmitted from the power management module to the second receiving module 440 by means of hardware interrupt. Alternatively, the second status signal may be first sent by the power management module to the computing module by means of software instructions, and then forwarded by the computing module to the second receiving module 440.

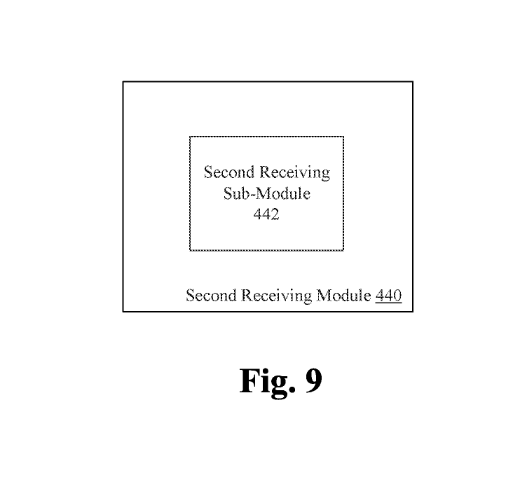

FIG. 9 is a block diagram of the second receiving module 440 shown in FIG. 8, according to another exemplary embodiment. Referring to FIG. 9, the second receiving module 440 further includes a second receiving sub-module 442.

The second receiving sub-module 442 is configured to receive the second status signal from the computing device, wherein the second status signal is first sent by the power management module to the computing device and then forwarded by the computing device to the second receiving sub-module 442. In this embodiment, the second status signal is transmitted between the power management module, the computing module, and the second receiving sub-module 442 by means of software instructions.

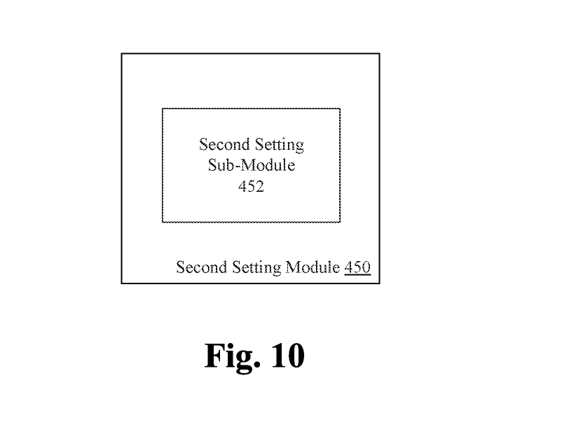

FIG. 10 is a block diagram of the second setting module 450 shown in FIG. 8, according to another exemplary embodiment. Referring to FIG. 10, the second setting module 450 further includes a second setting sub-module 452.

The second setting sub-module 452 is configured to set a second scanning frequency corresponding to the second status signal.

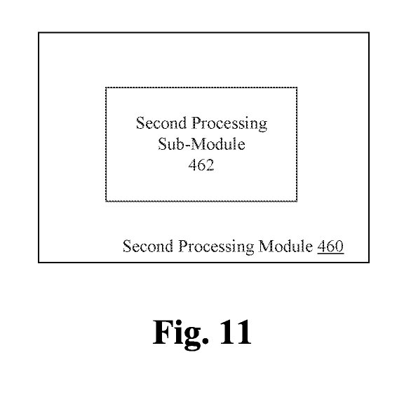

FIG. 11 is a block diagram of the second processing module 460 shown in FIG. 8, according to another exemplary embodiment. Referring to FIG. 11, the second processing module 460 further includes a second processing sub-module 462.

The second processing sub-module 462 works in conjunction with the second setting sub-module 452 (FIG. 10) and is configured to process touch events sensed by the touch screen, according to the second sensitivity threshold and the second scanning frequency.

The disclosed apparatus embodiments generally correspond to the disclosed method embodiments. Specific implementations of the functions and roles of the modules/units described above can be referred to the above-described methods, which are not elaborated herein.

These apparatus embodiments are exemplary only. The above-described modules/units can be constructed in part or in whole according to the actual needs for implementing the solutions provided by the present disclosure. One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

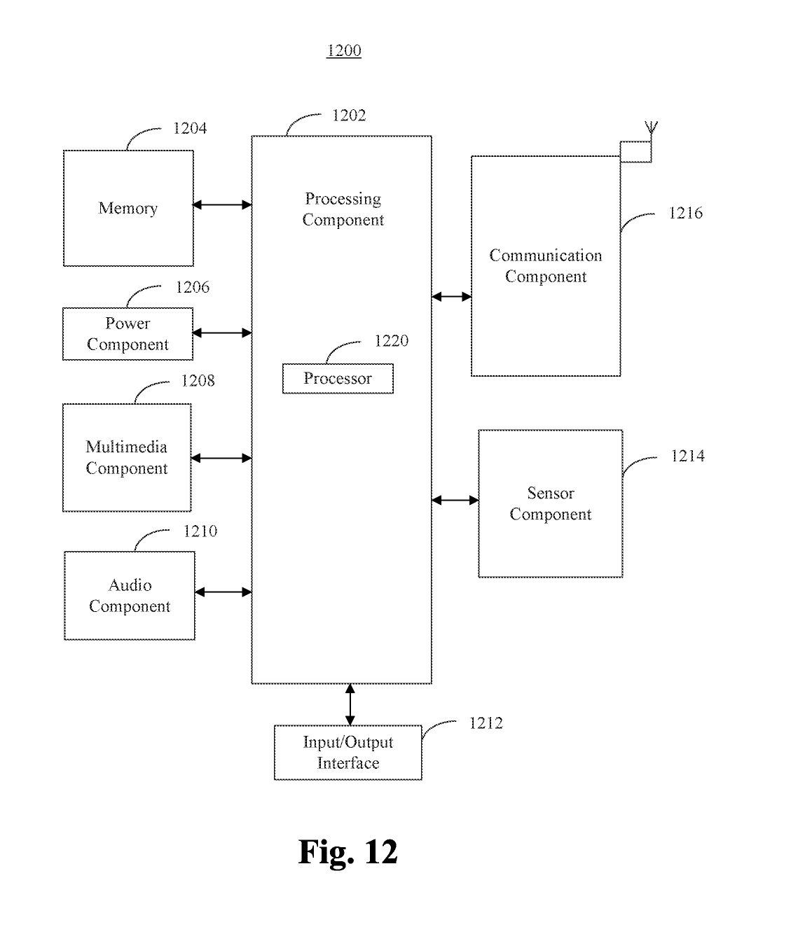

FIG. 12 is a block diagram of an apparatus 1200 for controlling touch-screen sensitivity, according to an exemplary embodiment. For example, the apparatus 1200 may be a mobile telephone having routing function, a computer, a digital broadcasting terminal, a message sending and receiving device, a games console, a tablet device, a medical device, a fitness device, a personal digital assistant and so on.

Referring to FIG. 12, the apparatus 1200 includes one or more of the following components: a processing component 1202, a memory 1204, a power supply component 1206, a multimedia component 1208, an audio component 1210, an input/output (I/O) interface 1212, a sensor component 1214, and a communication component 1216.

The processing component 1202 typically controls overall operations of the apparatus 1200, such as operations associated with display, telephone calls, data communication, camera operations, and recording operations. The processing component 1202 includes one or more processors 1220 to execute instructions to perform all or some of the steps in the above described methods. Moreover, the processing component 1202 includes one or more modules which facilitate the interaction between the processing component 1202 and other components. For instance, the processing component 1202 includes a multimedia module to facilitate the interaction between the multimedia component 1208 and the processing component 1202.

The memory 1204 is configured to store various types of data to support the operation of the apparatus 1200. Examples of such data include instructions for any applications or methods operated on the apparatus 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1206 provides power to various components of the apparatus 1200. The power supply component 1206 includes a power management system, one or more power sources, and any other components associated with the generation, management, and distribution of power in the apparatus 1200.

The multimedia component 1208 includes a screen providing an output interface between the apparatus 1200 and the user. In some embodiments, the screen includes a liquid crystal display (LCD) and/or a touch panel. If the screen includes the touch panel, the screen may be implemented as a touch screen to receive input signals from the user. The touch panel includes one or more touch sensors to sense touches, swipes, and other gestures performed on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and/or the rear camera receives external multimedia data while the apparatus 1200 is in an operation mode, such as a photographing mode or a video mode. Each of the front camera and the rear camera may be a fixed optical lens system or have focus and optical zoom capability.

The audio module 1210 is configured to output and/or input audio signals. For example, the audio module 1210 includes a microphone configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. These buttons include, but are not limited to: a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200. The sensor component 1214 may also detect a change in position of the apparatus 1200 or a component thereof, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a complementary metal oxide semiconductor (CMOS) or a charge coupled device (CCD) image sensor, for use in imaging applications. In some embodiments, the sensor module 1214 also includes an accelerometer sensor, a gyroscope sensor, a magnetic sensor, a pressure sensor, a microwave sensor, or a temperature sensor.

The communication component 1216 is configured to facilitate communication, wired or wirelessly, between the apparatus 1200 and other devices. The apparatus 1200 can access a wireless network based on a communication standard, such as WiFi, 2G, 3G, 4G, 5G, or a combination thereof. In one exemplary embodiment, the communication component 1216 receives a broadcast signal or broadcast associated information from an external broadcast management system via a broadcast channel In one exemplary embodiment, the communication component 1216 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1204, executed by the processor 1220 in the apparatus 1200 to implement the above-described methods. For example, the non-transitory computer-readable storage medium may be a ROM, a random access memory (RAM), a CD-ROM, a magnetic tape, a floppy disc, an optical data storage device, and the like.

Other embodiments of the invention will be apparent to those skilled in the art from consideration of the specification and practice of the invention disclosed here. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for use in a touch screen of a terminal, the method comprising:
receiving a first status signal sent by a power management device of the terminal when the power management device detects a charging port of the terminal is in a connected state, the first status signal indicating the charging port is in the connected state;
setting a first sensitivity threshold corresponding to the first status signal;
processing touch events sensed by the touch screen to generate touch-point information according to the first sensitivity threshold; and
sending the touch-point information generated according to the first sensitivity threshold to a computing device of the terminal.

2. The method according to claim 1, wherein the receiving of the first status signal sent by the power management device of the terminal further includes:
receiving the first status signal from the computing device of the terminal, wherein the computing device receives the first status signal from the power management device.

3. The method according to claim 1, wherein the setting of the first sensitivity threshold corresponding to the first status signal further includes:
setting a first scanning frequency corresponding to the first status signal.

4. The method according to claim 3, wherein the processing of the touch events sensed by the touch screen to generate the touch-point information according to the first sensitivity threshold further includes:
processing the touch events sensed by the touch screen to generate the touch-point information according to the first sensitivity threshold and the first scanning frequency.

5. The method according to claim 1, further comprising:
receiving a second status signal sent by the power management device when the power management device detects that the charging port is in an idle state, the second status signal indicating the charging port is in the idle state;
setting a second sensitivity threshold corresponding to the second status signal, the second sensitivity threshold being lower than the first sensitivity threshold;
processing the touch events sensed by the touch screen to generate the touch-point information according to the second sensitivity threshold; and
sending the touch-point information generated according to the second sensitivity threshold to the computer device.

6. The method according to claim 5, wherein the receiving of the second status signal sent by the power management device further includes:
receiving the second status signal from the computing device, wherein the computing device receives the second status signal from the power management device.

7. The method according to claim 5, wherein the setting of the second sensitivity threshold corresponding to the second status signal further includes:
setting a second scanning frequency corresponding to the second status signal.

8. The method according to claim 7, wherein the processing of the touch events sensed by the touch screen to generate the touch-point information according to the second sensitivity threshold further includes:
processing the touch events sensed by the touch screen to generate the touch-point information according to the second sensitivity threshold and the second scanning frequency.

9. An apparatus for controlling sensitivity of a touch screen of a terminal, the apparatus comprising:
a processor, and
a memory configured to store instructions executable by the processor;
wherein the processor is configured to:
receive a first status signal sent by a power management device of the terminal when the power management device detects a charging port of the terminal is in a connected state, the first status signal indicating the charging port is in the connected state;
set for the touch screen a first sensitivity threshold corresponding to the first status signal;
process touch events sensed by the touch screen to generate touch-point information according to the first sensitivity threshold; and
send the touch-point information generated according to the first sensitivity threshold to a computing device of the terminal.

10. The apparatus according to claim 9, wherein the processor is further configured to:
receive the first status signal from the computing device, wherein the computing device receives the first status signal from the power management device.

11. The apparatus according to claim 9, wherein the processor is further configured to:
set for the touch screen a first scanning frequency corresponding to the first status signal.

12. The apparatus according to claim 11, wherein the processor is further configured to:
process the touch events sensed by the touch screen to generate the touch-point information according to the first sensitivity threshold and the first scanning frequency.

13. The apparatus according to claim 9, wherein the processor is further configured to: receive a second status signal sent by the power management device when the power management device detects that the charging port is in an idle state, the second status signal indicating the charging port is in the idle state;
set for the touch screen a second sensitivity threshold corresponding to the second status signal, the second sensitivity threshold being lower than the first sensitivity threshold; and
process the touch events sensed by the touch screen to generate the touch-point information according to the second sensitivity threshold; and
send the touch-point information generated according to the second sensitivity threshold to the computing device.

14. The apparatus according to claim 13, wherein the processor is further configured to:
receive the second status signal from the computing device, wherein the computing device receives the second status signal from the power management device.

15. The apparatus according to claim 13, wherein the processor is further configured to:
set for the touch screen a second scanning frequency corresponding to the second status signal.

16. The apparatus according to claim 15, wherein the processor is further configured to:
process the touch events sensed by the touch screen to generate the touch-point information according to the second sensitivity threshold and the second scanning frequency.

17. A non-transitory computer-readable storage medium comprising instructions that, when executed by a processor of a terminal, causes the terminal to perform a method for controlling sensitivity of a touch screen of the terminal, the method comprising:
receiving a first status signal sent by a power management device of the terminal when the power management device detects a charging port of the terminal is in a connected state, the first status signal indicating the charging port is in the connected state;
setting for the touch screen a first sensitivity threshold corresponding to the first status signal;
processing touch events sensed by the touch screen to generate touch-point information according to the first sensitivity threshold; and
sending the touch-point information generated according to the first sensitivity threshold to a computing device of the terminal.
